(19) United States
(12) Patent Application Publication
(10) Pub. No.: US 2014/0067570 A1
(43) Pub. Date: Mar. 6, 2014

(54) SYSTEM AND METHOD FOR MOBILE POINT OF SALE

(71) Applicants: Uttam Sengupta, Portland, OR (US); Selim Aissi, Beaverton, OR (US); Venky Venkateswaran, Folsom, CA (US); Abhilasha Bhargav-Spantzel, Santa Clara, CA (US)

(72) Inventors: Uttam Sengupta, Portland, OR (US); Selim Aissi, Beaverton, OR (US); Venky Venkateswaran, Folsom, CA (US); Abhilasha Bhargav-Spantzel, Santa Clara, CA (US)

(21) Appl. No.: 13/976,164

(22) PCT Filed: Oct. 1, 2011
(86) PCT No.: PCT/US2011/054504

§ 371 Date: Nov. 21, 2013

(51) Int. Cl. G06Q 20/32

(52) U.S. Cl. CPC G06Q 20/3226
USPC 705/21

(57) ABSTRACT

In some embodiments, an electronic device comprises an input interface, a communication interface, a processor, and logic to launch, in the electronic device, a shopping application associated with one or more specific vendors, establish, via the communication interface, a communication connection between the electronic device and a shopping server, and receive, via the input interface, an identifier associated with one or more products sold by the one or more specific vendors, receive, via the communication interface, point of sale information associated with the one or more products associated with the identifier, receive, via the communication interface, a transaction authorization to purchase the one or more products associated with the identifier, and execute the purchase transaction on the electronic device. Other embodiments may be described.

### BACKGROUND

The subject matter described herein relates generally to the field of electronic commerce and more particularly to systems and methods which enable a mobile communication terminal to function as point of sale (POS) terminal.

Electronic commerce sites on the World Wide Web have made possible a range of electronic shopping experiences. However, the conventional “brick and mortar” shopping experience remains essentially unchanged in that consumers are required to pass goods and services through a conventional, centralized checkout process that presents an inconvenience to consumers. Accordingly, improved checkout processes may find utility.

### BRIEF DESCRIPTION OF THE DRAWINGS

The detailed description is described with reference to the accompanying figures.

FIG. 1 is a schematic illustration of a system for mobile point of sale according to some embodiments.

FIG. 2 is a schematic illustration of an electronic device for use in performing mobile point of sale according to some embodiments.

FIG. 3 is a schematic illustration a computing device which may be adapted for use in a mobile point of sale system in accordance with some embodiments.

FIGS. 4-5 are flowcharts illustrating operations implemented in a mobile point of sale system according to some embodiments.

### DETAILED DESCRIPTION

Described herein are exemplary systems and methods for mobile point of sale. In some embodiments, a mobile device such as a mobile phone or the like is configured to include a mobile point of sale application that executes on the mobile device. In operation, the mobile point of sale application enables the mobile device to interact with a vendor's transaction system(s) to execute purchase transactions. For example, the application may enable a user in a brick and mortar store to scan a bar code or optical tag associated with one or more products or services provided by a vendor using an input interface on the electronic device. The application may then, alone or in cooperation with other computing systems, identify the products or services and download point of sale information to the mobile device. The point of sale information may be presented on a user interface and a user of the device may be provided with purchasing options for the products or services. If the user elects to purchase the products or services, the transaction may be conducted on the mobile device, thereby eliminating the need to go through a conventional check-out process.

In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

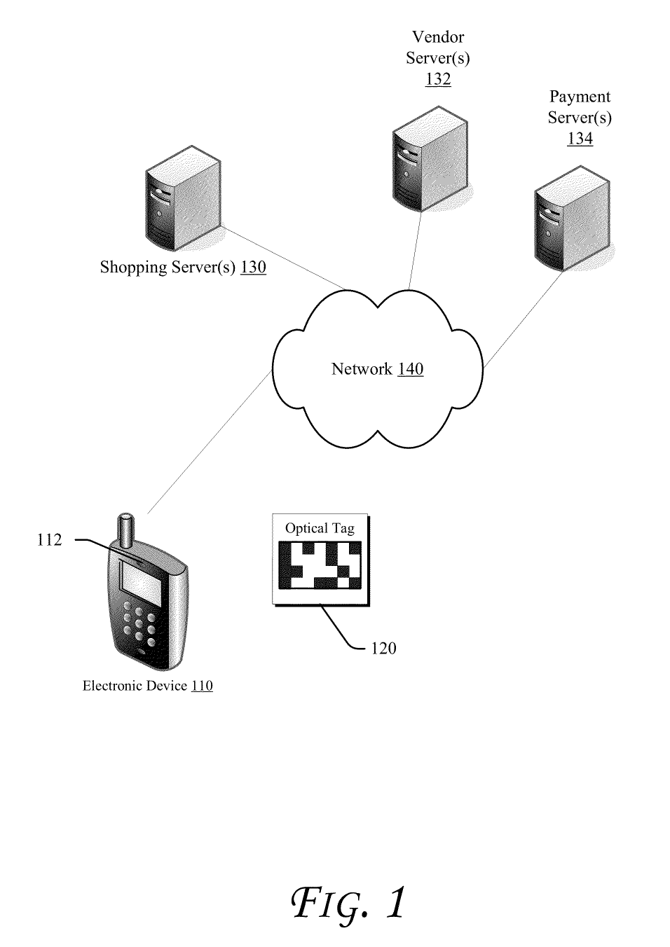

FIG. 1 is a schematic illustration of a system for mobile point of sale according to some embodiments. Referring to FIG. 1, an electronic device 110 may be coupled to one or more servers 130, 132, 134 via a network 140. In some embodiments electronic device 110 may be embodied as a mobile telephone, tablet, PDA or other mobile computing device as described with reference to electronic device 110, below. Network 140 may be embodied as a public communication network such as, e.g., the interne, or as a private communication network, or combinations thereof

Servers 130, 132, 134 may be embodied as computer systems. In some embodiments the server 130 may be embodied as a shopping server and may be managed by a vendor or by a third party which operates a mobile point of sale shopping platform. Vendor server(s) 132 may be operated by a vendor of goods or services, and payment server(s) 134 may be operated by a vendor or by a third-party payment system, e.g., a transaction clearing service or a credit card service.

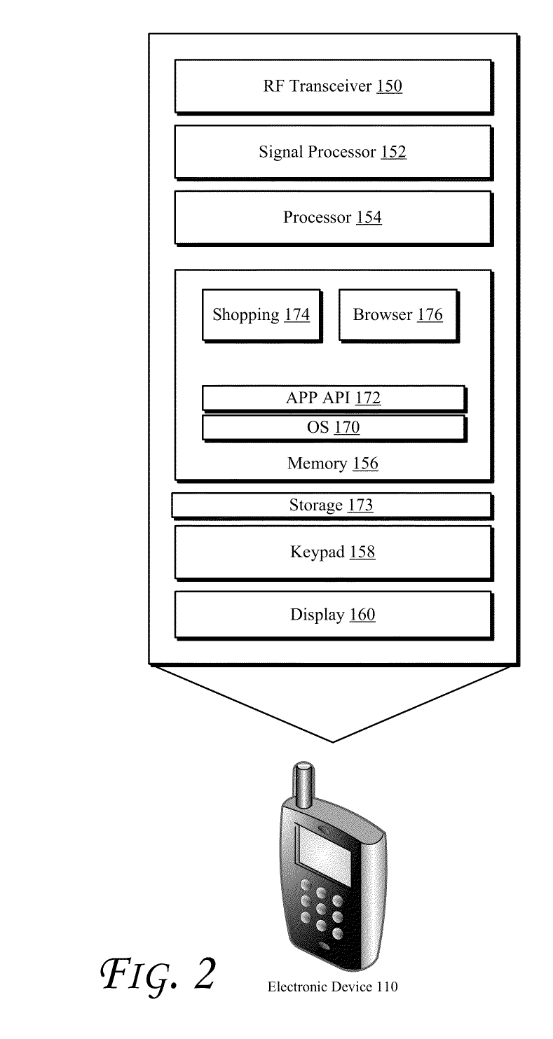

FIG. 2 is a schematic illustration of an electronic device for use in performing mobile point of sale according to some embodiments. Referring to FIG. 1B, in some embodiments electronic device 110 may be embodied as a mobile telephone, a tablet, a personal digital assistant (PDA) or the like. Electronic device 110 may include an RF transceiver 150 to transceive RF signals and a signal processing module 152 to process signals received by RF transceiver 150.

RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN--Part II: Wireless LAN Medium Access Control (MAC) and Physical Layer (PHY) specifications Amendment 4: Further Higher Data Rate Extension in the 2.4 GHz Band, 802.11G-2003). Other examples of a wireless interface would be a Long-term

Evolution (LTE), Wideband Code Division Multiple Access (WCDMA), general packet radio service (GPRS) interface (see, e.g., Guidelines on GPRS Handset Requirements, Global System for Mobile Communications/GSM Association, Ver. 3.0.1, December 2002).

Electronic device 110 may further include a processor 154 and a memory module 156. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 154 may be one or more processors in the family of Intel® Atom™ processors and Intel® Atom™ based System-on-a-Chip (SOC) available from Intel® Corporation of Santa Clara, Calif. Alternatively, other CPUs/SOCs may be used, based on Intel and/or ARM CPU cores. Also, one or more processors from other manufactures may be utilized. Moreover, the processors may have a single or multi core design. In some embodiments, memory module 156 includes random access memory (RAM); however, memory module 156 may be implemented using other memory types such as dynamic RAM (DRAM), synchronous DRAM (SDRAM), and the like.

An operating system 170 may reside in memory 156 and may be executed by processor 154 when electronic device 110 is powered up. An application programming interface (API) may provide an interface between the operating system 170 and one or more applications which execute on the processor 154 In some embodiments the operating system 170 may be embodied as an Android operating system, a UNIX operating system or any derivative thereof (e.g., Linux, etc.), a Windows® brand operating system, or any other mobile operating system. Besides Memory module 156, electronic device 110 will also have a non-volatile storage module 173 (e.g., eMMC).

Electronic device 110 may further include one or more input/output interfaces such as, e.g., a keypad 158 and a display 160. In some embodiments electronic device 110 may not have a keypad and use the touch panel for input.

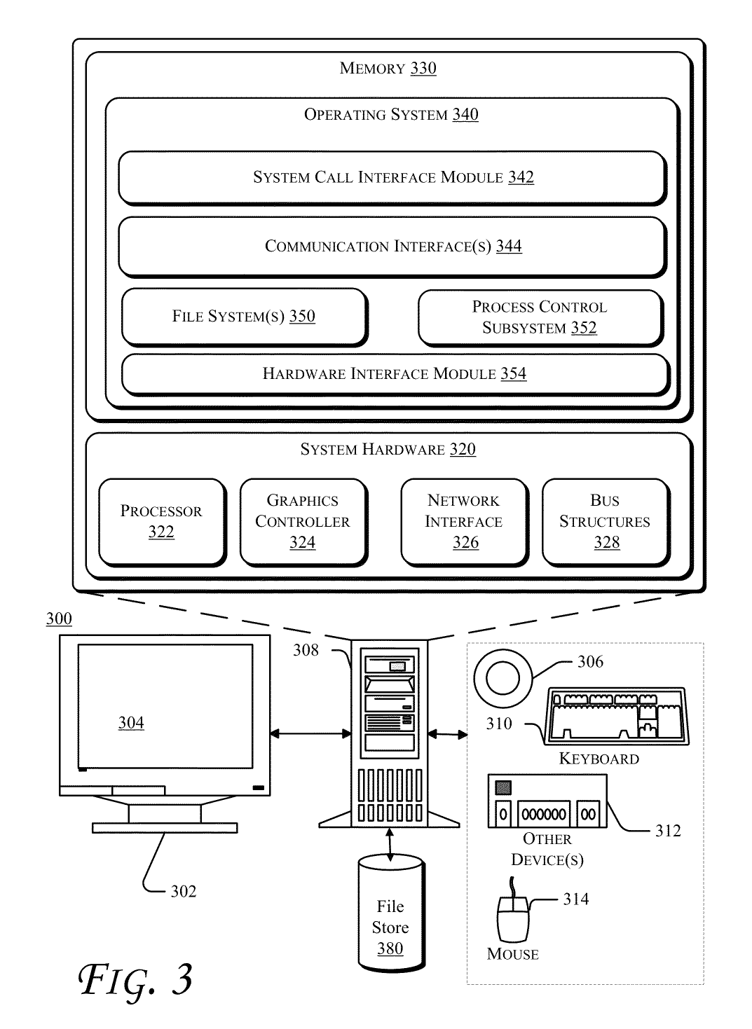

FIG. 3 is a schematic illustration of a computing system 300 that may be used to implement servers 130, 132, or 134. In some embodiments, system 300 includes a computing device 308 and one or more accompanying input/output devices including a display 302 having a screen 304, one or more speakers 306, a keyboard 310, one or more other I/O device(s) 312, and a mouse 314. The other I/O device(s) 312 may include a touch screen, a voice-activated input device, a track ball, and any other device that allows the system 300 to receive input from a user.

The computing device 308 includes system hardware 320 and memory 330, which may be implemented as random access memory and/or read-only memory. A file store 380 may be communicatively coupled to computing device 308. File store 380 may be internal to computing device 308 such as, e.g., one or more hard drives, CD-ROM drives, DVD-ROM drives, or other types of storage devices. File store 380 may also be external to computer 308 such as, e.g., one or more external hard drives, network attached storage, or a separate storage network.

System hardware 320 may include one or more processors 322, video controllers 324, network interfaces 326, and bus structures 328. In one embodiment, processor 322 may be embodied as an Intel ® Pentium we processor, or an Intel Itanium® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics controller 324 may function as an adjunction processor that manages graphics and/or video operations. Graphics controller 324 may be integrated onto the motherboard of computing system 300 or may be coupled via an expansion slot on the motherboard.

In one embodiment, network interface 326 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN-Part II: Wireless LAN Medium Access Control (MAC) and Physical Layer (PHY) specifications Amendment 4: Further Higher Data Rate Extension in the 2.4 GHz Band, 802.11G-2003).

Bus structures 328 connect various components of system hardware 328. In one embodiment, bus structures 328 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 330 may include an operating system 340 for managing operations of computing device 308. In one embodiment, operating system 340 includes a hardware interface module 354 that provides an interface to system hardware 320. In addition, operating system 340 may include a file system 350 that manages files used in the operation of computing device 308 and a process control subsystem 352 that manages processes executing on computing device 308.

Operating system 340 may include (or manage) one or more communication interfaces that may operate in conjunction with system hardware 320 to transceive data packets and/or data streams from a remote source. Operating system 340 may further include a system call interface module 342 that provides an interface between the operating system 340 and one or more application modules resident in memory 330. Operating system 340 may be embodied as a UNIX operating system or any derivative thereof (e.g., Linux, Solaris, etc.) or as a Windows® brand operating system, or other operating systems.

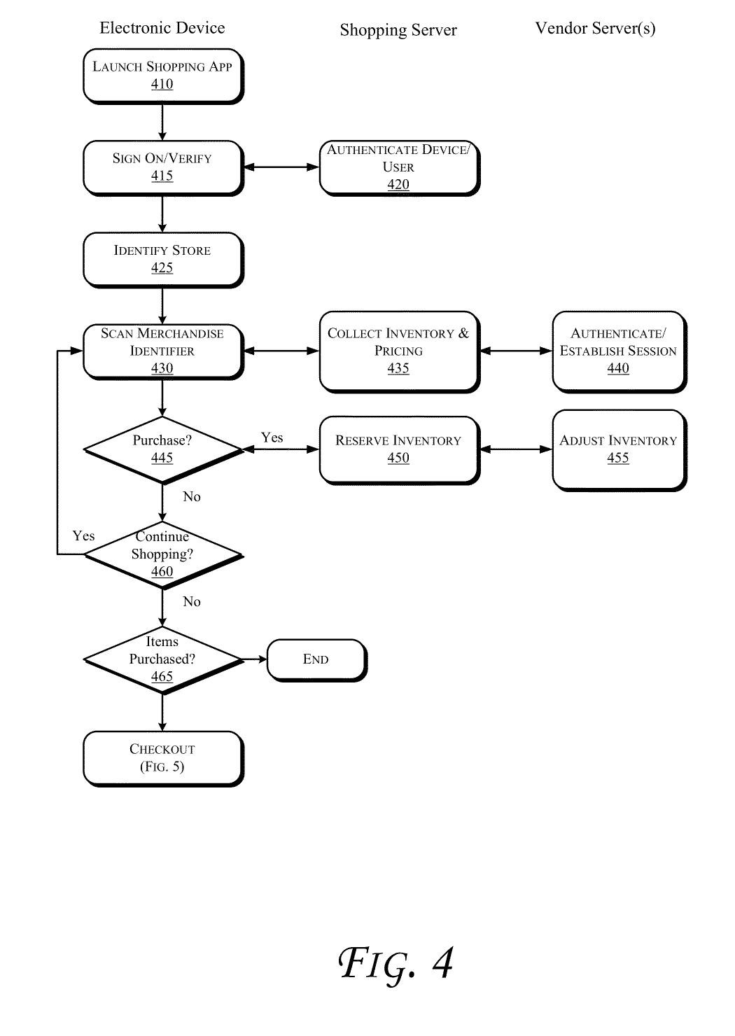

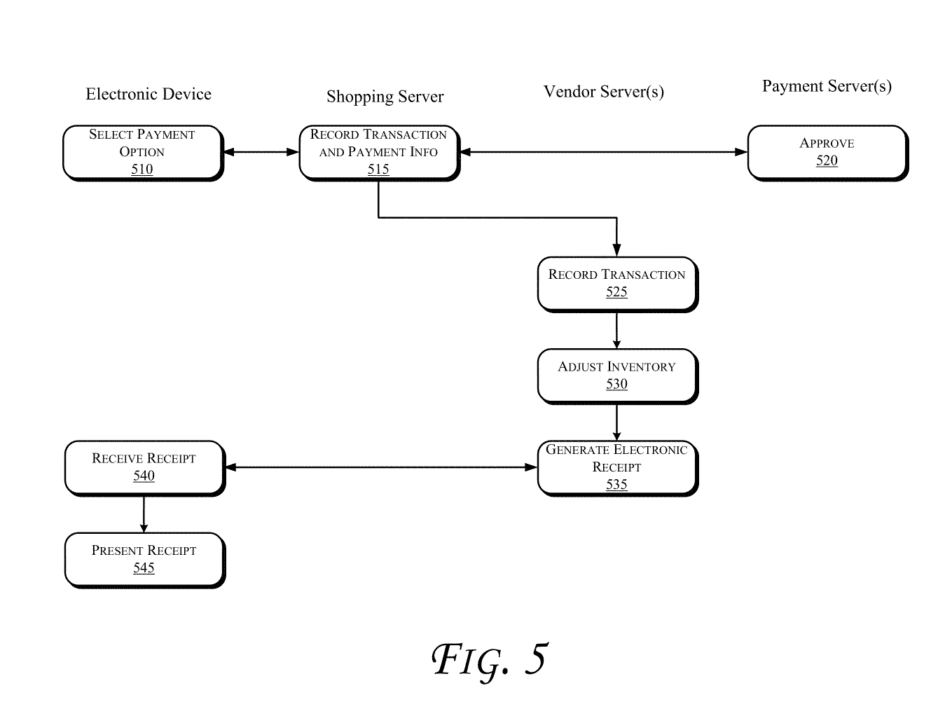

In some embodiments, electronic device 110, in cooperation with one or more of the servers 130, 132, 134, may be configured to facilitate mobile point of sale operations. FIGS. 4-5 are flowcharts illustrating operations implemented in a mobile point of sale system according to some embodiments. Referring first to FIG. 4, at operation 410 a shopping application 174 is launched on an electronic device such as electronic device 110. In some embodiments the shopping application 174 may be associated with a specific vendor of goods or services, while in other embodiments the shopping application 174 may be operated by an independent organization and may be used across multiple vendor platforms.

By way of example, in some embodiments a user may launch shopping application 174 by entering an input on a user interface of the electronic device 110. Alternatively, the shopping application 174 may launch automatically in response to detecting a condition. For example, a shopping application may detect when the electronic device is within a predetermined distance of a retail store operated by a particular vendor and may launch automatically on the electronic device.

At operation 415 a user of the electronic device signs on to the shopping application, e.g., by entering a username and a password. In response to a login operation the electronic device 110 initiates a communication session with a shopping server 130, which authenticates at least one of the electronic device 110 or the user of the electronic device. In some embodiments the authentication process may incorporate additional techniques besides user name/password combinations. By way of example, the authentication process may include one or more challenge-response components such as a Completely Automated Public Turing test to tell Computers and Humans Apart (“CAPTCA”) test, multi-factor authentication (e.g., biometrics) and one time passwords (OTP)

In alternate embodiments, or in addition, the authentication process may include a location-based authentication process that determines whether the electronic device is within a predetermined location. For example, the authentication process may utilize a geolocation service to determine whether the electronic device is within a predetermined location. Alternatively, in some embodiments the shopping application 174 may cause the electronic device 110 to transmit a signal which may be detected by a receiver in a vendor location. The receiver device may, in turn, report the location of the electronic device 110 to the shopping server 130 via a network 140.

At operation 425 the shopping application 174 identifies the store or location in which the device is located. By way of example, in some embodiments vendors may install signal transmitters in stores which transmit a signal that includes a location code identifying the store in which the electronic device is located. The electronic device 110 may receive the signal via the RF transceiver 150 and process the signal to determine the location code. In other embodiments the shopping application may request a user to enter a location code via a keypad or to scan an optical tag, such as optical tag 120 depicted in FIG. 1, which includes a location code.

At operation 430 a merchandise identifier is scanned. In some embodiments the merchandise identifier may comprise an optical tag such as the optical tag 120 depicted in FIG. 1, a bar code, or other printed identifier. In other embodiment a merchandise identifier may be embedded in a Radio Frequency Identifier (RFID) tag or other electromagnetic mechanisms. In further embodiments a user may be asked to enter an alphanumeric identifier via keypad 158 or via a touchpad on display 160.

The merchandise identifier is transmitted from the electronic device 110 to a shopping server 130, and at operation 435 the shopping server collects point of sale information including inventory and pricing information for the products or services associated with the merchandise identifier. In some embodiments the shopping server 130 may initiate a communication session with one or more vendor servers 132, which may authenticate the shopping server and/or the electronic device and user. The point of sale information collected by the shopping server is returned to the electronic device 110, and the shopping application presents at least portions of the point of sale information on a user interface such as the display 160.

A user of the electronic device 110 may then be prompted to make a purchase decision. If at operation 445 the user elects to purchase the products or services associated with the merchandise identifier then control passes to operation 450 and inventory associate with product identifier is reserved, and may be placed in logical “shopping cart” associated with the user's session. By way of example, in some embodiments the shopping server 130 places a reservation on the inventory with a vendor server 132. In response, the vendor server 132 may adjust current inventory levels associated with the product or service associated with the merchandise identifier, at operation 455.

Control then passes to operation 460, at which the user may be presented with an option to continue shopping. If the user elects to continue shopping then control passes back to operation 430 and the user may continue to evaluate products and services. The operations 430-460 may continue in a loop until the user is ready to check out. If, at operation 465, the user has not purchased any items then the shopping application may end. By contrast, if there are items for purchase then a checkout process is invoked.

FIG. 5 is a flowchart illustrating operations in one embodiment of a checkout process. Referring to FIG. 5, at operation 510 a user selects a payment option. By way of example, a user may choose to pay with a credit card, an electronic payment, or similar means. The payment option is forwarded to the shopping server 130, which may initiate an approval process with a payment server 134, which approves or declines the payment transaction. The response from the payment server is transmitted back to the shopping server 130. If the payment option is declined then the user may be presented with an opportunity to try another payment option. By contrast, if the payment option is accepted then the transaction information may be transmitted back to the electronic device 110.

In response to an approved payment transaction, the shopping server may forward an approved transaction message to the vendor server 134. In response, the vendor server 134 records transaction and payment details associated with the transaction (operation 525), adjusts the inventory of the purchased products and services (operation 530), and generates an electronic receipt (operation 535).

The electronic receipt may be transmitted to the electronic device 110. At operation 540 the electronic device receives the electronic receipt, and at operation 545 the electronic device presents the receipt on a user interface, e.g., the display 160.

Thus, described herein is a system and method to enable an electronic device such as a mobile phone or the like to be used as a point of sale terminal, thereby enabling users of the system to bypass conventional checkout procedures.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1-20. (canceled)

21. A computer program product comprising logic instructions stored on a non-transitory computer readable medium, which when executed by a processor in an electronic device, configure the processor to implement mobile point of sale operations, comprising:
launching, in the electronic device, a shopping application associated with one or more specific vendors;
establishing a communication connection between the electronic device and a shopping server;
receiving, in the electronic device, an identifier associated with one or more products sold by the one or more specific vendors;
receiving, from the mobile shopping server, point of sale information associated with the one or more products associated with the identifier;
receiving, in the electronic device, a transaction authorization to purchase the one or more products associated with the identifier; and
executing the purchase transaction on the electronic device.

22. The computer program product of claim 21, wherein the mobile point of sale operations further comprise initiating an authentication process to authenticate a user of the electronic device.

23. The computer program product of claim 22, wherein the authentication process further comprises authenticating a location of the electronic device to ensure that the electronic device is in a location approved by the one or more specific vendors.

24. The computer program product of claim 21, wherein receiving, in the electronic device, an identifier associate with one or more products sold by the one or more specific vendors comprises receiving, from an input device on the electronic device, an input representing the identifier, wherein the input comprises at least one of a bar code, an optical tag code, RFID or a numeric code.

25. The computer program product of claim 24, further comprising:
generating an electronic signal from the input representing the identifier; and
transmitting the electronic signal from the electronic device to the shopping server.

26. The computer program product of claim 25, wherein, in response to the electronic signal, the shopping server retrieves point of sale information related to the one or more products associated with the identifier and transmits the point of sale information to the electronic device.

27. The computer program product of claim 25, wherein executing the purchase transaction on the electronic device comprises validating the transaction with a payment processing server.

28. The computer program product of claim 27, further comprising:
receiving, in the electronic device, an electronic receipt for the executing the purchase transaction on the electronic device; and
presenting the electronic receipt on a display.

29. An electronic device, comprising:
an input interface;
a communication interface;
a processor; and
logic to:
launch, in the electronic device, a shopping application associated with one or more specific vendors;
establish, via the communication interface, a communication connection between the electronic device and a mobile shopping server;
receive, via the input interface, an identifier associated with one or more products sold by the one or more specific vendors;
receive, via the communication interface, point of sale information associated with the one or more products associated with the identifier;
receive, via the communication interface, a transaction authorization to purchase the one or more products associated with the identifier; and
execute the purchase transaction on the electronic device.

30. The electronic device of claim 29, further comprising logic to initiate an authentication process to authenticate a user of the electronic device.

31. The electronic device of claim 30, further comprising logic to authenticate a location of the electronic device to ensure that the electronic device is in a location approved by the one or more specific vendors.

32. The electronic device of claim 29, further comprising logic to receive, via the input interface, an input representing the identifier, wherein the input comprises at least one of a bar code, an optical tag code, or a numeric code.

33. The electronic device of claim 32, further comprising logic to:
generate an electronic signal from the input representing the identifier; and
transmit the electronic signal from the electronic device to the mobile shopping server.

34. The electronic device of claim 33, further comprising logic to, in response to the electronic signal, retrieve point of sale information related to the one or more products associated with the identifier and transmit the point of sale information to the electronic device.

35. The electronic device of claim 34, further comprising logic to validate the transaction with a payment processing server.

36. The electronic device of claim 29, further comprising logic to:
receive, in the electronic device, an electronic receipt for the executing the purchase transaction on the electronic device; and
present the electronic receipt on a display.

37. A method, comprising:
launching, in an electronic device, a shopping application associated with one or more specific vendors;
establishing a communication connection between the electronic device and a shopping server;
receiving, in the electronic device, an identifier associated with one or more products sold by the one or more specific vendors;
receiving, from the mobile shopping server, point of sale information associated with the one or more products associated with the identifier;
receiving, in the electronic device, a transaction authorization to purchase the one or more products associated with the identifier; and
executing the purchase transaction on the electronic device.

38. The method of claim 37, further comprising initiating an authentication process to authenticate a user of the electronic device.

39. The method of claim 38, wherein the authentication process further comprises authenticating a location of the electronic device to ensure that the electronic device is in a location approved by the one or more specific vendors.

40. The method of claim 37, wherein receiving, in the electronic device, an identifier associate with one or more products sold by the one or more specific vendors comprises receiving, from an input device on the electronic device, an input representing the identifier, wherein the input comprises at least one of a bar code, an optical tag code, RFID or a numeric code.
